(19) United States
(12) Patent Application Publication
(10) Pub. No.: US 2012/0296078 A1
(43) Pub. Date: Nov. 22, 2012

(54) ACETYLATED CELLULOSE ETHER AND ARTICLES COMPRISING THE SAME

(75) Inventors: Gyung Don Kang, Daejeon (KR); Hyun Young Park, Daejeon (KR); Jin Kyu Kang, Daejeon (KR)

(73) Assignee: SAMSUNG FINE CHEMICALS CO., LTD., Ulsan (KR)

(21) Appl. No.: 13/521,832

(22) PCT Filed: Oct. 11, 2010
(86) PCT No.: PCT/KR10/06938

§ 371 Date: Jul. 12, 2012

(30) Foreign Application Priority Data
Feb. 1, 2010 (KR) 10-2010-0009159

(51) Int. Cl. C08B 13/00

(52) U.S. Cl. 536/66

(57) ABSTRACT

Acetylated cellulose ether and an article including the same. The acetylated cellulose ether has a degree of substitution (DS) of alkyl group of 1 to 2, a molar substitution (MS) of hydroxyalkyl group of 0 to 1, and a degree of substitution (DS) of acetyl group of 1 to 2.

### TECHNICAL FIELD

The present invention relates to acetylated cellulose ether and an article including the same, and more particularly, to acetylated cellulose ether having a degree of substitution (DS) of alkyl group of 1 to 2, a molar substitution (MS) of hydroxyalkyl group of 0 to 1, and a degree of substitution (DS) of acetyl group of 1 to 2, and an article including the acetylated cellulose ether.

### BACKGROUND ART

Cellulose has three hydroxyl groups (—OH) per unit glucose ring, and these hydroxyl groups form regular inter and intramolecular hydrogen bonds. Since the hydrogen bonds may form a rigid crystalline structure, cellulose including the hydrogen bonds has a stable structure that is not soluble in water or in organic solvents.

However, cellulose ether formed by substituting at least one of the hydroxyl groups in a glucose unit with various substituents by etherification, has an amorphous structure due to breakage of hydrogen bonds, and is thereby soluble in water. zo Examples of the water-soluble cellulose ether include methylcellulose, hydroxypropylmethylcellulose, hydroxyethylmethylcellulose, hydroxyethylcellulose, and hydroxypropylcellulose. The cellulose ether is easily dissolved in water and has a water retention and an excellent film forming ability so as to be widely used in thickeners for construction, pharmaceutical capsules, detergents, cosmetics, etc. However, due to the water-soluble property of the cellulose ether, the cellulose ether cannot be used as films for packing that requires water resistance. In addition, since cellulose and cellulose ether do not have a specific melting point, they are thermally decomposed and thus cannot be applied to melt processing such as injection molding.

Meanwhile, in order to provide solubility in an organic solvent with the cellulose ether, the molar substitution (MS) of hydroxypropyl groups of cellulose ether is increased to 0.5 or greater or acetylating process of hydroxypropylmethylcellulose has been reported in U.S. Pat. No. 3,940,384). However, since the cellulose ether prepared according to the former method is dissolved in only limited organic solvents and also soluble in water, it cannot be used for products that require water resistance. Furthermore, since there is no specific melting point, the cellulose ether cannot be applied to melt processing such as injection molding. In addition, even though the acetylated hydroxypropylmethylcelluose prepared by U.S. Pat. No. 3,940,384) method is water resistant, it is soluble in only limited organic solvents due to a low degree of substitution (DS) of methyl group (0.1 to 1), and a high molar substitution (MS) of hydroxypropyl group (2 to 8) but is not soluble in other organic solvents such as acetone. Also, since there is no specific melting point, the acetylated hydroxypropylmethylcelluose cannot be applied to melt processing such as injection to molding.

In case of cellulose acetate, it is synthesized using a strong inorganic acid as a catalyst is commercially used to manufacture membranes, films, and fibers. However, a backbone of the cellulose acetate is hydrolyzed by the strong acid during the synthesis so that intrinsic mechanical strength of cellulose is lost, and only limited types of organic solvents can dissolve the cellulose acetate.

### DISCLOSURE OF INVENTION

### Technical Problem

The present invention provides acetylated cellulose ether having a degree of substitution (DS) of alkyl group of 1 to 2, a molar substitution (MS) of hydroxyalkyl group of 0 to 1, and a degree of substitution (DS) of acetyl group of 1 to 2.

The present invention also provides an article including the acetylated cellulose ether.

### Technical Solution

According to an aspect of the present invention, there is provided acetylated cellulose ether having a degree of substitution (DS) of alkyl group of 1 to 2, a molar substitution (MS) of hydroxyalkyl group of 0 to 1, and a degree of substitution (DS) of acetyl group of 1 to 2.

The acetylated cellulose ether may be prepared by acetylating at least one cellulose ether selected from the group consisting of methylcellulose, hydroxypropylmethylcellulose, and hydroxyethylmethylcellulose.

A viscosity of a solution of 2 wt % acetylated cellulose ether in acetone may be in the range of 5 to 100,000 cps when measured at 200 and at 20 rpm using a Brookfield viscometer.

A melting point of the acetylated cellulose ether may be in the range of 180 to 250 □.

According to an aspect of the present invention, there is provided an article including acetylated cellulose ether.

The article may include packing materials, fibers, case of home appliances, case of mobile phones, or paint removers.

### ADVANTAGEOUS EFFECTS OF INVENTION

The acetylated cellulose ether according to the present embodiment is insoluble in water but soluble in an organic solvent, and has high mechanical strength. Thus, it may be applied to manufacture of films for packing and fibrous articles. In addition, the acetylated cellulose ether may be used to manufacture cases of home appliances and mobile phones by injection-molding, or the like, since it has a specific melting point. Furthermore, the acetylated cellulose ether has biodegradability, and thus may be used to manufacture eco-friendly plastics. The acetylated cellulose ether is similar to cellulose acetate, in that both have the acetyl group. However, while cellulose acetate has low mechanical strength for its low molecular weight by hydrolysis during the synthesis, acetylated cellulose ether may have high mechanical strength since it can have high molecular weight.

### BEST MODE FOR THE INVENTION

Hereinafter, acetylated cellulose ether and an article including the acetylated cellulose ether according to embodiments of the present invention will be described in more detail.

The acetylated cellulose ether according to an embodiment of the present invention is prepared by acetylation of cellulose ether having a degree of substitution (DS) of alkyl group of 1 to 2 and a molar substitution (MS) of hydroxyalkyl group of 0 to 1. In this regard, the alkyl group may have 1 to 16 carbon atoms.

The acetylated cellulose ether may have a DS of acetyl group of 1 to 2.

By the acetylation of the cellulose ether having the DS of alkyl group and the MS of hydroxyalkyl group within the ranges described above, acetylated cellulose ether may be obtained. The acetylated cellulose ether is not dissolved in water but is dissolved in an organic solvent such as acetone so as to be processed by solvent casting, wet spinning, or dry spinning. It has also a specific melting point so as to be applied to melt processing such as injection molding and melt spinning. It has high molecular weight ensuring excellent mechanical strength.

The acetylated cellulose ether may be prepared by acetylating at least one celluloseether selected from the group consisting of methylcellulose, hydroxypropylmethylcellulose, and hydroxyethylmethylcellulose.

In addition, a viscosity of a solution prepared by dissolving the acetylated cellulose ether in acetone to a concentration of the acetylated cellulose ether of 2 wt % may be in the range of 5 to 100,000 cps when measured at 20 □ and at 20 rpm using a Brookfield viscometer. If the viscosity of the solution is within the range described above, the acetylated cellulose ether has excellent mechanical strength.

The acetylated cellulose ether may have a melting point in the range of 180 to 250 □. If the melting point of the acetylated cellulose ether is within the range described above, the acetylated cellulose ether may be applied to melt processing such as injection molding.

Hereinafter, a method of preparing acetylated cellulose ether according to an embodiment of the present invention will be described in detail.

First, cellulose ether is prepared by etherifying a hydroxyl group of cellulose. Then, a hydroxyl group in the prepared cellulose ether is substituted with an acetyl group (CH₃CO^{—}) (acetylation) to prepare acetylated cellulose ether. Formulae 1 and 2 show processes of converting anhydroglucose, as a basic repeating unit of cellulose, into a basic repeating unit of acetylated cellulose ether by etherification and acetylation of the anhydroglucose.

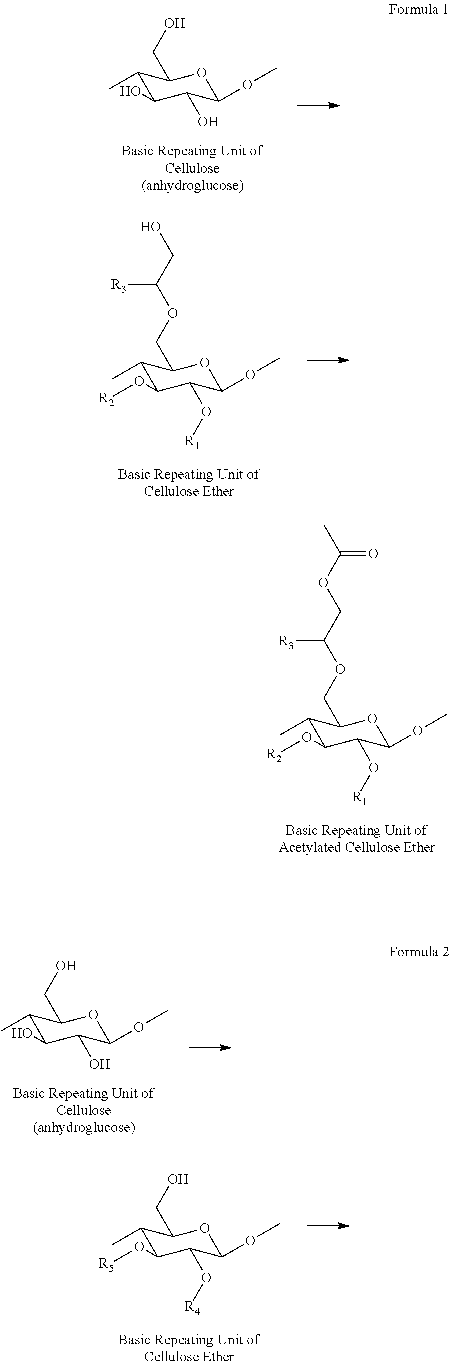

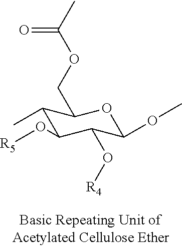

Formula 1 shows that the cellulose is converted into hydroxyalkylalkylcellulose by etherification, and then the hydroxyalkylalkylcellulose is converted into acetylated cellulose ether by acetylation, and Formula 2 shows that the cellulose is converted into alkylcellulose by etherification, and then the alkylcellulose is converted into acetylated cellulose ether by acetylation.

In Formula 1, R₁ and R₂ may be each independently H, CH₃, CH₂CH₂OH, or to CH₂CH(CH₃)OH, and R₃ may be H or CH₃.

In Formula 2, R₄ and R₅ are each independently H or CH₃, and at least one of R₄ and R₅ is CH₃.

The term “degree of substitution (DS) of alkyl group” used herein indicates the average number of hydroxyl groups substituted with alkyl group(s) per anhydroglucose unit. Since one anhydroglucose unit may include three hydroxyl groups, a theoretical maximum DS of alkyl group is 3 when substituted with a mono-functional substituent.

However, a multi-functional or polymerizable substituent may react with hydroxyl group contained in the anhydroglucose unit, and also react with itself, so that a DS thereof is not limited to 3. In addition, the term “molar substitution (MS) of hydroxyalkyl group” used herein indicates the number of moles of hydroxyalkyl group(s) substituted per anhydroglucose unit. There is no theoretical maximum value of the MS of hydroxyalkyl group. The term “degree of substitution (DS) of acetyl group” used herein indicates the number of moles of acetyl group(s) substituted per anhydroglucose unit.

The acetylated cellulose ether according to the present embodiment may be prepared by substituting most of the hydroxyl groups that are contained in cellulose ether with hydrophobic acetyl groups. Thus, the acetylated cellulose ether is not soluble in water, but is soluble in an organic solvent.

Meanwhile, an article according to another embodiment of the present invention includes the acetylated cellulose ether. Examples of the article include packing materials, fibers, case of home appliances, case of mobile phones, or paint removers. Hereinafter, one or more embodiments will be described in detail with reference to the following examples. However, these examples are not intended to limit the purpose and scope of the invention.

### EXAMPLES

### Examples 1 to 9 and Comparative Example 1: Preparation of Acetylated Cellulose Ether

70 g of cellulose ether, 1120 g of acetic anhydride, and 350 g of pyridine were added to a 3L reactor equipped with a stirrer, and the mixture was maintained at 90 □ for 3 hours while stirring at 200 rpm to prepare acetylated cellulose ether. Here, pyridine was used as a catalyst. The DS of methyl group, the MS of hydroxyalkyl group, and the viscosity of each of the cellulose ethers that were used in Examples 1 to 9 and Comparative Example 1 are listed in Table 1 below.

TABLE 1

| | Cellulose ether | | | |
|---|---|---|---|---|
| | | | MS of | |
| | | DS of methyl | hydroxylalkyl | Viscosity |
| | Type | group | group | (cps) |
| Example 1 | PMC15M | 1.85 | 0.23 | 200 |
| Example 2 | PMB40H | 1.83 | 0.18 | 4000 |
| Example 3 | PMT19U | 1.61 | 0.07 | 19000 |
| Example 4 | PMC50U | 1.39 | 0.22 | 55000 |
| Example 5 | PMH9860 | 1.21 | 0.83 | 32000 |
| Example 6 | MC40H | 1.91 | — | 4000 |
| Example 7 | EMA70U | 1.44 | 0.28 | 50000 |
| Example 8 | EMB80H | 1.47 | 0.23 | 8000 |
| Example 9 | EMC50U | 1.85 | 0.31 | 50000 |
| Comparative | HPMC 1 | 0.55 | 4.80 | 3500 |
| Example 1 | | | | |

In table 1, each of the cellulose ethers used in Examples 1 to 9 was commercially manufactured by Samsung Fine Chemicals, Co., Ltd., and HPMC 1 used in Comparative Examples 1 was a hydroxypropylmethylcellulose.
In Table 1, the viscosity of a 2 wt % cellulose ether aqueous solution was measured at 20□ and at 20 rpm using a Brookfield viscometer.

### Evaluation Example

Evaluation example Evaluation of Physical Properties of Acetylated Cellulose Ether

The viscosity, DS of acetyl group, melting point, and solubility in various organic solvents of each of the acetylated cellulose ethers prepared according to Examples 1 to 9 and Comparative Example 1 were measured using the methods below, and the results are listed in Table 2.

### DS of Acetyl Group

Free acetic acid that is generated by saponification of an acetylated cellulose ether sample was titrated with an alkaline material to measure the DS of acetyl group of each acetylated cellulose ether (ASTM D871-96).

### Viscosity

Each of the acetylated cellulose ethers was dissolved in acetone to prepare a 2 wt % acetylated cellulose ether solution. Then, the viscosity of the prepared each solution was measured at 20 □ and at 20 rpm using a Brookfield viscometer.

### Melting Point

A DSC (NETZSCH, STA4 09PC) was used to measure a melting point of each acetylated cellulose ether. 50 mg of each acetylated cellulose ether was used as a sample for the DSC and the measurement was performed while heating the sample from 20 □ to 1000 □ at a heating rate of 1 □/min.

Solubility in Organic Solvent Each acetylated cellulose ether was mixed with methylene chloride (MeCI), acetic acid (AA), dimethyl sulfoxide (DMSO), pyridine (Prd), acetone (AT), tetrahydrofuran

(THF), and dimethyl acetamide (DMAc), respectively, and each mixture was stirred to identify whether the acetylated cellulose ether is dissolved in each of the organic solvents or not. In Table 2, O indicates a soluble material in organic solvents, and X indicates an insoluble material in organic solvents.

TABLE 2

| | DS of acetyl | Viscosity | Melting point | Solubility in organic solvent | | | | | | |
|---|---|---|---|---|---|---|---|---|---|---|
| | group | (cps) | (° C.) | MeCl | AA | DMSO | Prd | AT | THF | DMAc |
| Example 1 | 1.18 | 200 | 211 | ∘ | ∘ | ∘ | ∘ | ∘ | ∘ | ∘ |
| Example 2 | 1.16 | 3800 | 203 | ∘ | ∘ | ∘ | ∘ | ∘ | ∘ | ∘ |
| Example 3 | 1.33 | 17000 | 198 | ∘ | ∘ | ∘ | ∘ | ∘ | ∘ | ∘ |
| Example 4 | 1.57 | 53500 | 218 | ∘ | ∘ | ∘ | ∘ | ∘ | ∘ | ∘ |
| Example 5 | 1.77 | 31000 | 185 | ∘ | ∘ | ∘ | ∘ | ∘ | ∘ | ∘ |
| Example 6 | 1.05 | 3700 | 195 | ∘ | ∘ | ∘ | ∘ | ∘ | ∘ | ∘ |
| Example 7 | 1.58 | 51000 | 218 | ∘ | ∘ | ∘ | ∘ | ∘ | ∘ | ∘ |
| Example 8 | 1.51 | 7800 | 208 | ∘ | ∘ | ∘ | ∘ | ∘ | ∘ | ∘ |
| Example 9 | 1.16 | 47000 | 213 | ∘ | ∘ | ∘ | ∘ | ∘ | ∘ | ∘ |
| Comparative | 2.43 | Insoluble | Not melted | ∘ | ∘ | ∘ | ∘ | x | x | x |
| Example 1 | | in acetone | and thermally | | | | | | | |
| | | | decomposed | | | | | | | |

Referring to Table 2, the acetylated cellulose ether prepared according to Examples 1 to 9 were soluble in more types of organic solvents than the acetylated cellulose ether prepared according to Comparative Example 1, and had a melting point in the range of 185 to 218 □. On the other hand, the acetylated cellulose ether prepared according to Comparative Example 1 was not soluble in acetone (AT), tetrahydrofuran (THF), and dimethyl acetamide (DMAc), and was not melted and thermally decomposed. The acetylated cellulose ether prepared according to Examples 1 to 9 may be used in various fields when compared to the acetylated cellulose ether prepared according to Comparative Example 1, and also applied to melt processing such as injection molding.

While the present invention has been particularly shown and described with reference to exemplary embodiments thereof, it will be understood by those of ordinary skill in the art that various changes in form and details may be made therein without departing from the spirit and scope of the present invention as defined by the following claims.

1. Acetylated cellulose ether having a degree of substitution (DS) of alkyl group of 1 to 2, a molar substitution (MS) of hydroxyalkyl group of 0 to 1, and a degree of substitution (DS) of acetyl group of 1 to 2.

2. The acetylated cellulose ether of claim 1, wherein the acetylated cellulose ether is prepared by acetylating at least one cellulose ether selected from the group consisting of methylcellulose, hydroxypropylmethylcellulose, and hydroxyethylmethylcellulose.

3. The acetylated cellulose ether of claim 1, wherein a viscosity of a solution of 2 wt % acetylated cellulose ether in acetone is in the range of 5 to 100,000 cps when measured at 20° C. and at 20 rpm using a Brookfield viscometer.

4. The acetylated cellulose ether of claim 1, wherein a melting point of the acetylated cellulose ether is in the range of 180 to 250° C.

5. An article comprising acetylated cellulose ether according to claim 1.

6. The article of claim 5, wherein the article comprises packing materials, fibers, case of home appliances, case of mobile phones, or paint removers.

7. An article comprising acetylated cellulose ether according to claim 2.

8. An article comprising acetylated cellulose ether according to claim 3.

9. An article comprising acetylated cellulose ether according to claim 4.
